(19) United States
(12) Patent Application Publication
(10) Pub. No.: US 2008/0267142 A1
(43) Pub. Date: Oct. 30, 2008

(54) Distributed Antenna Wlan Access-Point System and Method

(75) Inventors: Mordechai Mushkin, Nirit (IL); Dan Raphaeli, Kfar Saba (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: STELLARIS LTD., Tel Aviv (IL)

(21) Appl. No.: 11/570,342

(22) PCT Filed: Jun. 19, 2005
(86) PCT No.: PCT/IL2005/000655

§ 371 Date: Dec. 11, 2006

Related U.S. Application Data
(60) Provisional application No. 60/580,351, filed on Jun. 18, 2004.

(51) Int. Cl. H04Q 7/24

(52) U.S. Cl. 370/338

(57) ABSTRACT

A wireless local area network (WLAN) access point (AP) system comprises a first plurality of distributed remote antenna units operative to transmit and receive RF signals and a central WLAN beam-forming unit connected to each distributed remote antenna unit and operative to provide communication between the antenna units and a second plurality of wireless clients. The WLAN AP system can be used for simultaneous communications with the wireless clients over the same radio frequency (RF) channel while avoiding mutual interferences.

### FIELD AND BACKGROUND OF THE INVENTION

The present invention relates to a WLAN infrastructure and more specifically to a WLAN access-point (AP) system with distributed antenna units that is capable of communicating with several WLAN clients simultaneously over the same radio-frequency (RF) channel.

A block diagram example of a previous art WLAN infrastructure system is illustrated in FIG. 1. A prior art system 100 includes one or several Access Points (AP) 102a-n that serve many wireless clients 104a-j. APs 102a-n are connected to the local area network (LAN) of an organization 106. The APs are typically connected to the LAN using 100 Mbps Ethernet protocol over CAT5 cables. A system with a small service area and low traffic requirements may comprise a single AP, but in order to achieve large coverage area and/or high traffic, several APs 102 are required, as explained below. It is noted, however, that one of the limitations of prior art systems is that such increase of AP density in order to increase throughput is not efficient, and reaches a saturation point wherein adding more APs does not add further capacity.

FIG. 2 illustrates a block diagram of a prior art AP 102, which typically comprises the following functions: an antenna 202, a RF transceiver 204, a base-band function 206, a PHY function 208, a MAC function 210, a LAN interface 212, a frequency source 214 and a processor (typically referred to as central processing unit or “CPU”) 216. RF transceiver 204 has a receiving path and a transmitting path. The transmitting path converts input analog base-band signals received from base-band function 206 into RF signals transmitted through antenna 202. The receiving path detects the RF signals received from the antenna and converts them into analog base-band signals forwarded to base-band function 206. Base-band function 206 converts analog base-band signals received from transceiver 204 into digitized signals forwarded to PHY 208 and digitized signals received from PHY 208 into analog base-band signals forwarded to transceiver 204. Frequency source 214 provides reference frequency signals for the RF and base-band functions. LAN interface 212 may be for example an Ethernet interface as described in IEEE standard 802.3. Optionally, an AP may be powered by a power-over-Ethernet technology as described in IEEE standard 802.3af. CPU 216 performs various control and management operations and may also participate in performing the MAC functions mainly in order to reduce the complexity of the dedicated hardware.

PHY 208 refers to the digital signal processing functions related to the first layer of the well known OSI (Open System Interconnection) seven layers model of ISO (International Standards Organization), for example as described in IEEE standard 802.11 and its derivatives 802.11a, 802.11b, and 802.11g. The main functions performed by PHY 208 include modulation, demodulation, encoding, decoding and synchronization. MAC 210 refers to various functions related to the second layer of the OSI seven layers model. Both PHY 208 and MAC 210 may perform functions beyond the scope of the corresponding layer of the ISO model. One major task of MAC 210 is to perform the media access control protocol that determines access rights and access timing to the media, for example as described in IEEE standard 802.11. It is to be understood that PHY and MAC are functions, which may be implemented in various combinations of dedicated hardware devices (for example application specific integrated circuits) and/or digital signal processors and/or general-purpose processors.

A system with a small service area and low traffic requirements may comprise a single AP, but in order to achieve large coverage area and/or high throughput, several APs 102 are required, as explained next.

Large coverage area: A given AP is able to communicate with wireless clients 104 within some given area, referred to as the “coverage area” of the AP. The coverage area is determined by the actual propagation conditions between the AP and the wireless clients. A typical coverage radius might range from a few tens to a few hundreds of meters. In cases where it is not possible to cover the entire desired area by a single AP, a prior art system must include several APs, which are distributed in the space such that almost every point in the desired area is covered by at least one AP.

High throughput: In a typical prior art system 100, a given AP usually serves several wireless clients. A particular AP is able to communicate with only one wireless client at a time. Therefore, the serving of several wireless clients simultaneously by a given AP is performed by means of time-sharing and the throughput capacity of the given AP is shared between the wireless clients being served. If the traffic capacity of the given AP is not sufficient to fulfill the aggregated traffic requirements of the wireless clients associated with the given AP, it is desired to install more APs, so that each AP will serve fewer wireless clients.

A significant general limitation of existing WLAN infrastructure systems appears whenever such a system comprises several prior art APs. In such a case, several transmissions might take place simultaneously over the different cells, and mutual interferences may occur between neighboring cells (where “cell” refers to an AP and the clients it serves). A number of methods are available for avoiding such mutual interferences. The most straightforward one is to allocate the neighboring cells with different RF channels in order to maintain enough spatial separation between co-channel cells. This method is referred to as “RF planning”. Significant limitations of RF planning include:
1) The spectrum currently allocated to WLAN is limited, and therefore the number of RF channels within the allocated spectrum is also limited. In the 2.4 GHz Industrial Scientific & Medical (ISM) unlicensed frequency there are only 3 non-overlapping 802.11b/g channels, and in the 5 GHz unlicensed national information infrastructure (U-NII) band there are only about 10 802.11a channels.
2) WLAN receivers operate at positive signal-to-noise ratio (SNR), which means that the range of interference is much larger than the range of the communication. For example, two nodes that communicate at their maximal range in SNR=20 dB, can be interfered by a third node with a three-times larger distance from the receiving node. Such interference will (in free space) be received at 10 dB lower power than the intended receiver, reducing its SNR to 10 dB.
3) In WLAN, the same RF channel is used for downlink transmissions (AP to client) and uplink transmissions (client to AP). Therefore, interference occurs not only between simultaneous transmissions of the same direction (simultaneous downlink transmissions shown in FIG. 3A or simultaneous uplink transmissions shown in FIG. 3B) but also between simultaneous transmissions of different directions (downlink transmission interfering with uplink transmission, and uplink transmission interfering with downlink transmission are shown in FIG. 3C and FIG. 3D, respectively). As can be seen from the deployment example in FIG. 3E, elimination of uplink to downlink interference requires a maximal spatial separation between co-channel cells.
4) Adjacent channel rejection (ACR) in IEEE 802.11g and IEEE 802.11a is relatively low (from −1 dB at 54 mbps to 16 dB at 6 mbps). As illustrated in FIG. 3E, the spatial separation between clients at adjacent cells might be very small, and therefore the uplink to downlink interferences between them may be higher than the adjacent channel rejection stated above. Therefore, for 802.11g and 802.11a, adjacent channels should preferably not be allocated to adjacent cells.

To one of ordinary skill in the art, there is thus a need for, and it would be highly advantageous to have a WLAN infrastructure based on plurality of distributed antenna units and a corresponding method, both of which enable simultaneous communication with a plurality of WLAN clients over the same RF channel without mutual interferences. It is also highly desirable to have a WLAN infrastructure system and corresponding method which are economical to build and install.

### SUMMARY OF THE INVENTION

The present invention relates to a WLAN AP system with distributed antenna units which is capable of communicating with several WLAN clients simultaneously over the same RF channel. The present invention successfully addresses limitations of existing WLAN systems and methods. The system of the present invention is readily implemented using standard hardware.

Basic principles and details relating to components and methods needed for properly understanding the present invention are provided herein. Complete theoretical descriptions, details, explanations, examples, and applications of these and related subjects and phenomena are readily available in standard references in the field of communications, more specifically in the field of WLAN digital communications.

The present invention involves performing or completing selected tasks or steps manually, semi-automatically, fully automatically, and/or a combination thereof. Moreover, according to actual instrumentation and/or equipment used for implementing a particular preferred embodiment of the disclosed system and corresponding method, several selected steps of the present invention may be performed by hardware, by software on any operating system of any firmware, or by a combination thereof. In particular, when implemented in hardware, selected steps of the invention may be performed by a computerized network, a computer, a computer chip, a digital signal processor (DSP), an electronic circuit, hard-wired circuitry, or a combination thereof, involving a plurality of digital and/or analog, electrical and/or electronic, components, operations, and protocols. Additionally, or alternatively, when implemented in software, selected steps of the invention may be performed by a data processor, such as a computing platform, which executes a plurality of computer program types of software instructions or protocols using any suitable computer operating system.

According to the present invention there is provided a WLAN AP system comprising a first plurality of distributed antenna units operative to transmit and receive RF signals, and a central WLAN beam-forming unit remote from and connected to each antenna unit and operative to provide communication to a second plurality of wireless clients through at least one of the antenna units, whereby the WLAN AP system can be used for simultaneous communications with more than one wireless clients over the same radio frequency (RF) channel.

According to the present invention there is provided a WLAN AP system comprising a central beam-forming unit operative to effect communications between a first plurality of wireless LAN clients through a second plurality of distributed antenna units that are remote from the central beam-forming unit, wherein the communications occur simultaneously over a single common RF channel.

According to the present invention there is provided in a WLAN infrastructure, a method for enabling simultaneous communication between a plurality of WLAN clients over the same RF channel without mutual interferences, comprising the steps of providing a first plurality of distributed antenna units, and using a central WLAN beam-forming unit connected remotely to each distributed antenna unit to effect simultaneous communications with at least some of the clients through at least some of the distributed antenna units over the same RF channel without mutual interferences. Phrases such as “without interference” and “interference-free” should be understood as, in a more accurate language, “with the mutual interference reduced to a level that enables reliable communication”.

According to the present invention there is provided a method for interference-free communication with a first plurality of WLAN clients over the same RF channel comprising the steps of using a second plurality of distributed antenna units positioned remotely from a central beam-forming unit to form a second plurality of beams in real time and using the second plurality of beams simultaneously over the same RF channel to facilitate the interference-free communication between the wireless clients.

According to the present invention there is provided a method for interference-free communication with N WLAN clients over the same RF channel comprising the steps of using M distributed antenna units located remotely from a central beam-forming unit to form N beams for the N clients in real time, wherein N is equal to or smaller than M, and communicating via the N beams simultaneously over the same RF channel with the N wireless clients.

### BRIEF DESCRIPTION OF THE DRAWINGS

The present invention is described herein by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the present invention. In this regard, no attempt is made to show structural details of the present invention in more detail than is necessary for a fundamental understanding of the invention, the description taken with the drawings making apparent to those skilled in the art how the several forms of the invention may be embodied in practice. Identical structures, elements or parts which appear in more than one figure are preferably labeled with a same or similar number in all the figures in which they appear. In the drawings:

FIG. 1 is a block diagram illustrating a prior art WLAN infrastructure;

FIG. 2 is a block diagram illustrating a prior art WLAN AP;

FIGS. 3A-E illustrate mutual interferences in prior art WLAN infrastructures;

FIG. 4 is a block diagram of a preferred embodiment of the WLAN infrastructure system of the present invention, showing a partition of the system into a central unit and a plurality of antenna units;

FIG. 5 is a more detailed block diagram of an antenna unit;

FIG. 6 is a more detailed block diagram of the central unit;

FIG. 7 is a block diagram illustrating an exemplary beam-forming processor, in accordance with the present invention;

FIG. 8 illustrates the operation of the MAC processor.

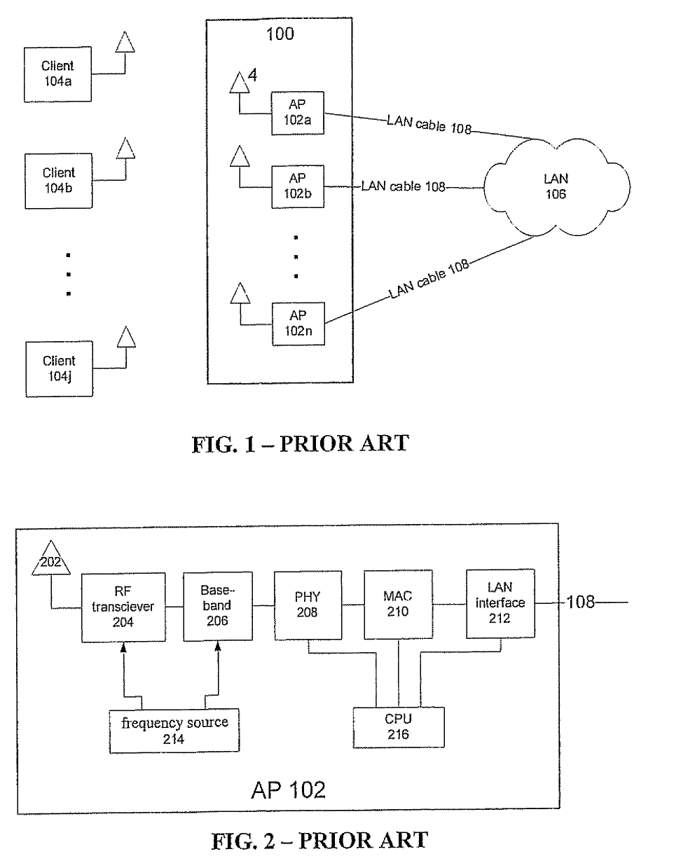

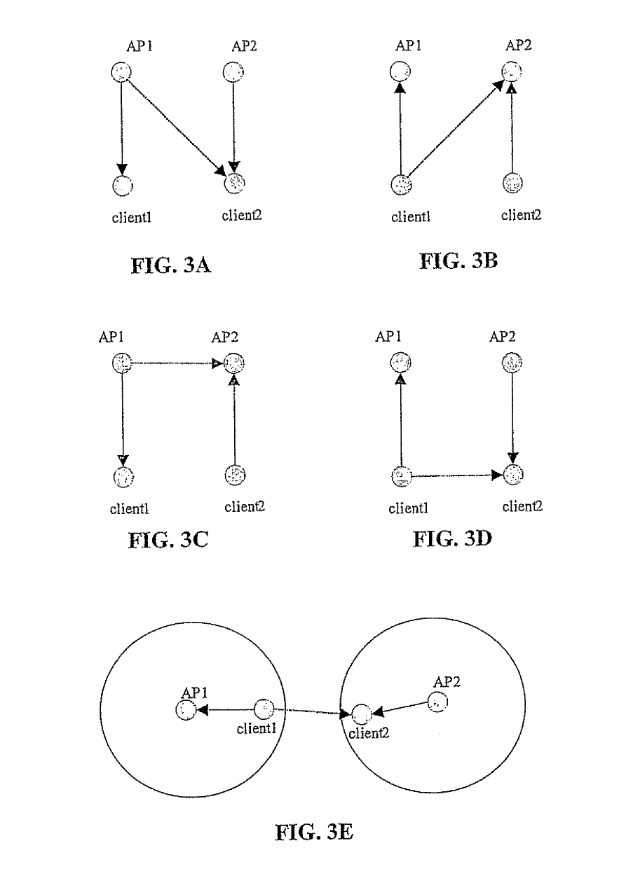

### DETAILED DESCRIPTION OF THE PREFERRED EMBODIMENTS

The present invention is of a WLAN AP infrastructure with distributed antenna units and of a corresponding method that provides a novel WLAN infrastructure. The preferred embodiments of the present invention are discussed in detail below. It is to be understood that the present invention is not limited to the details of construction, arrangement, and composition of the components of the system, and is not limited in its application to the details of the order or sequence of steps of operation or implementation of the corresponding method set forth in the following description, drawings, or examples. While specific steps, configurations and arrangements are discussed, it is to be understood that this is done for illustrative purposes only. A person skilled in the relevant art will recognize that other steps, configurations and arrangements can be used without departing from the spirit and scope of the present invention.

Construction, arrangement, and, composition of the system and, steps, operation, and implementation of the corresponding method thereof, according to the present invention are better understood with reference to the following description and accompanying drawings. Throughout the following description and accompanying drawings, like reference numbers refer to like elements.

In the following description of the system and corresponding method of the present invention, included are only main or principal components and steps needed for sufficiently understanding proper ‘enabling’ utilization and implementation of the disclosed system and method. Accordingly, descriptions of the various required or optional minor, intermediate, and/or, sub steps, which are readily known by one of ordinary skill in the art, and/or, which are available in the prior art and technical literature relating to WLAN and digital communication, are not included herein.

The present invention is capable of other embodiments or of being practiced or carried out in various ways. Also, it is to be understood that the phraseology, terminology, and, notation, employed herein are for the purpose of description and should not be regarded as limiting.

Steps, components, operation, and implementation of the coordinated system of antenna units and corresponding method providing a novel WLAN infrastructure, according to the present invention, are better understood with reference to the following description and accompanying drawings.

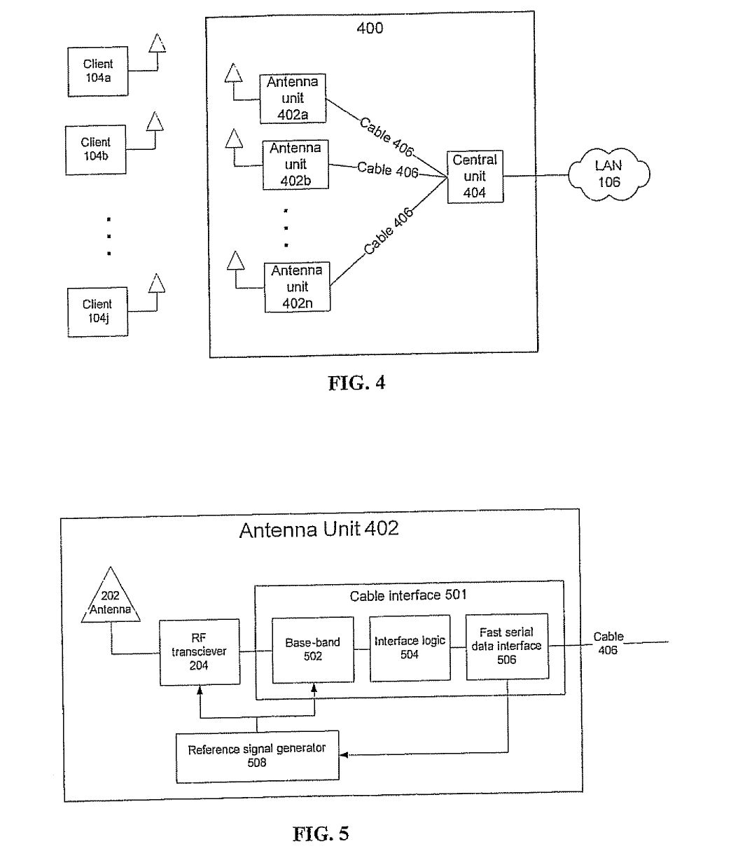

Referring now to the drawings, FIG. 4 is a block diagram illustrating a preferred embodiment of a novel WLAN infrastructure system 400 of the present invention. System 400 features several antenna units 402a-n and one central unit 404. Antenna units 402 are spread over the service area of the system and are connected by cables 406 to central unit 404, which is further connected to organization LAN 106. System 400 communicates with many WLAN clients 104 a-j and provides them with the same functional service as a prior art system but with improved performance, as explained below.

In an exemplary embodiment of the present invention, cables 406 connecting central unit 404 with antenna units 402 are twisted pair wires, adhering to a standard such as CAT5 (EIA/TIA 568A-5), CAT6, or CAT7, which are cost effective and easy to install. One advantageous aspect of the present invention is the utilization of a high speed digital link, such as 1000Base-T Ethernet, over twisted pair wires, such as CAT5, (EIA/TIA 568A-5), CAT6, or CAT7 as further described in detail below.

In other alternative embodiments, cables 406 may be twisted-pair cables, coaxial cables or fiber-optic cables carrying analog base-band, intermediate-frequency (IF) or radio-frequency (RF) signals or high speed digital representation of the signal. Cables 406 may also be fiber-optic cables carrying high speed digital links such as 1000Base-X (according to IEEE 802.3 standards).

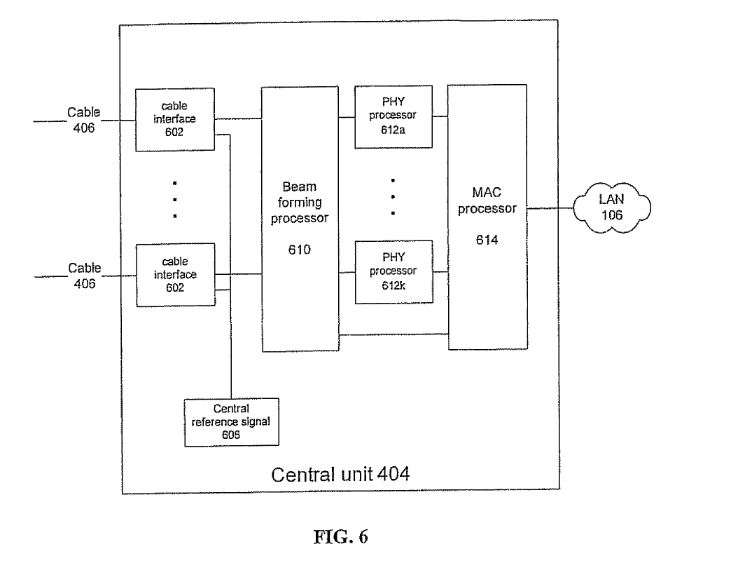

FIG. 5 is a more detailed block diagram of an antenna unit 402, while FIG. 6 is a more detailed block diagram of central unit 404. Antenna unit 402 comprises an antenna similar to antenna 202, an RF transceiver similar to RF transceiver 204, a cable interface 501 and a reference signal generator 508. In a preferred embodiment, cable interface 501 comprises a base-band function 502 similar to 206 in FIG. 2, an interface logic 504 and a fast serial data interface 506 (such as the PHY function of the 1000Base-T Ethernet, as described in IEEE 802.3).

Central unit 404 comprises a plurality of cable interfaces 602, a central reference source 606, a beam-forming processor 610 operative to perform WLAN beam-forming with distributed antennas, a plurality of PHY processors 612a-k and a multi-stream MAC processor 614. Each cable interface 602 may also include multiplexing of a special reference signal for clock generation in the antenna units. In a preferred embodiment, a cable interface 602 comprises a fast serial data interface 506. The function of beam-forming in WLAN with distributed antennas that are remote from a central beam-forming unit (also referred to as “distributed remote antenna units”) is a unique inventive feature of the present invention. This function is also referred to in this description simply as “WLAN beam-forming”, and central unit 404 is therefore also referred to as a “central WLAN beam-forming unit”.

The main function of beam-forming processor 610 is to eliminate mutual interferences between concurrent co-channel transmissions. Processor 610 enables PHY processors 612 to communicate with a plurality of wireless clients over the same RF channel without mutual interference. This means that a wireless client receives a “desired” signal produced by one of the PHY processors, ideally without receiving any of the signals produced at the same time by the other PHY processors. Without beam-forming as practiced in the present invention, the signals produced by the other PHY processors would interfere with the desired signal. With practical beam-forming, the other signals interference is considerably reduced. The same applies to the reverse link: in the case where several clients transmit simultaneously, a PHY processor receives a signal produced by one of the wireless clients, but none of the signals produced at the same time by the other wireless clients.

Returning to FIG. 5, an exemplary interface logic 504 functionality includes all or some of the following functions: format conversions between fast serial data interface 506 and base-band function 502, sampling rate conversion when needed, buffers, FIFOs, framing and de-framing of packets in and out of a continuous stream, extraction of commands such as transmit/receive, power level, self test, and inclusion of telemetry on the bit streaming. These functions are all well known in the art, but typically have to be tailored to the specific implementation in the WLAN infrastructure of the present invention. The function of reference signal generator 508 is similar to the function of frequency reference source 214 in FIG. 2. The difference is that while 214 is usually a free running frequency source, 508 is preferably locked on a central reference signal (606 in FIG. 6) incorporated in central unit 404. Alternatively, reference signal generator 508 may be free-running under conditions explained below.

In the transmission path, base-band function 502 converts the complex base-band waveform from a digitized format into an analog format. In the reception path, base-band function 502 converts the complex baseband waveform from an analog format into a digitized format. Exemplarily, base-band function 502 may be implemented by using ADCs, DACs, anti-aliasing filters, interpolation filters and decimation filters. Decimation and interpolation are used to decrease the bandwidth requirements from the high speed digital link. In an exemplary embodiment, samples transmitted over the cable in a sampling rate of 31.25 MHz are converted to a stream in a sampling rate of 62.5 MHz used in the DAC. The same occur in the receive path in the inverse direction. High sampling rates in the DAC or ADC reduces the anti-aliasing requirement and thus reduce the cost of the antenna unit.

The beam-forming algorithms described below are enabled by having all reference signal generators 508 of all antenna units 402a-n locked to the same central reference signal, thereby keeping the phase difference between signals transmitted/received by different antenna units 402 constant. This represents an inventive feature, because unlike prior art systems, the antenna units herein are not collocated. Reference signal generator 508 may also provide the sampling clock for the analog-to digital conversion (ADC) and digital-to-analog conversion (DAC) in the base-band function.

Other forms of synchronization can alternatively be used. For example one of the antenna units can send a synchronization signal to all or part of the other antenna units. Such a synchronization signal can be transmitted over the air, over the cables as an out of band signal, or using the digital interface internal clock distribution. Alternatively yet, an external unit not within the central unit or the antenna unit can supply the synchronization signal.

In order to have reference signal generator 508 of all antenna units 402a-n locked on the common central frequency signal, central reference source (also referred to as “central reference signal”) 606 incorporated in central unit 404 outputs a signal that is transmitted from central unit 404 to antenna units 402a-n over cables 406. This task can exemplarily be performed in a number of ways, as follows:

In the preferred embodiment, central reference signal 606 provides the reference clock for the transmitter of fast serial data interface 602. The clock is recovered by fast serial data interface 506 in antenna unit 402 and forwarded to reference signal generator 508.

In an alternative embodiment (referred to as “out-of-band” transmission), a special signal is multiplexed with the fast serial data signal. In this case, a fast serial data interface 602 includes a coupler to add the reference signal produced by central reference signal 606. At the antenna, fast serial data interface 506 includes filters to separate the reference from the fast serial data carrying signals. For example, the special signal may be a pure carrier wave in a frequency which is out of band of the fast serial data signal. A difference reference signal may be periodic pseudo noise (PN). The utilization of a PN signal may be necessary to maintain radiation from cables 406 below regulatory limits.

In yet another alternative embodiment, a stable and accurate frequency source may be incorporated in reference signal generator 508, thus keeping the phase difference between signals transmitted/received by different antenna units 402 relatively constant for short time periods (e.g. on the order of 100 ms to 1 sec), and tracking the low frequency phase variations as part of the channel estimation process.

Contrary to the common practice in WLAN art, where a given antenna is used to communicate with one client at a given time, in the present invention the antenna units of the WLAN infrastructure disclosed herein are used for creating a plurality of beams in real time. At any given time each beam communicates with a different wireless client 104, with no interference between beams, as explained below. The number of beams cannot exceed the number of antenna units. Since the number of beams created simultaneously in real-time is typically greater than one, the innovative WLAN AP system disclosed herein is capable of communicating simultaneously with several clients 104 over the same RF channel.

Exemplarily for the embodiment shown in FIGS. 5 and 6, the present invention introduces the novel use of high rate low latency digital links over twisted pair cables 406 between distributed antenna units 402 and central unit 404. Links 406 are provided by the PHY layer of the fast serial data Ethernet, and may exemplarily achieve a rate of 1 Gbit/sec, with a latency of less than 1 ms.

The following design example illustrates that the transmission capacity of the serial digital link over cables 406 is sufficient to carry the WLAN base-band signals from central unit 404 to antenna units 402 and vice-versa. Assuming that the WLAN base-band bandwidth (BW) is on the order of 10 MHz (complex), the minimal sampling rate of the signal is 20M samples/second, where each sample is a complex number. In practice, a higher sampling rate, for example 31.25M samples/second, is preferred. The dynamic range required for the base-band signals is estimated to be achieved by digitizing the base-band signal with at most 12 bits/sample. Therefore, the transmission capacity required to deliver the base-band signal is within the order of 31.25*2*12=750 Mbps which is well below the 1 Gbits/second capacity of the 1000Base-T Ethernet PHY.

WLAN Beam-Forming with Distributed Remote Antennas

Beam-forming is used to allow multiple signals to be sent to or received from multiple clients simultaneously, with minimal mutual interference. For example, let the number of clients served simultaneously be denoted by n. Assume n beams are formed, one beam for each of the n clients. The beams are formed using signal processing techniques, in such a way that each beam has n−1 “zeroes” at the n−1 location of the other n−1 wireless clients. This means that that the RF signal transmitted by a given beam (downlink operation) is received by the intended client, but is not received (or received at a much lower level) at the n−1 locations of the other n−1 clients, and that an RF signal transmitted by a given client (uplink operation) is received by the intended beam but is not received (or received at a much lower level) by the other n−1 beams.

Beam-forming, also referred to as “smart antenna”, is a known technique in cellular, fixed wireless access and WLAN applications. However, the beam-forming system and corresponding method of the present invention are inventively different from prior art beam-forming or smart antenna systems and methods. In prior WLAN art, all antenna elements are located at the same location, and the signals are transmitted from that location toward several different directions. In contrast, in the present invention the antenna units, which are equivalent to antenna elements, are distributed over the service area and are remote from the central beam-forming unit. The benefits of this distributed arrangement will be discussed below.

Beam-forming with distributed antennas for cellular applications has been described in US Patent application 2003/0092456 A1 “Communication System Employing Transmit Macro-Diversity” filed Jul. 21, 2001, and in “Enhancing the Cellular Down-Link Capacity via Co-Processing at the Transmitting End,” by S. Shamai and B. M. Zaidel, presented at the IEEE Semiannual Vehicular Technology, pp. 1745-1749, VTC2001 Spring Conference, Rhodes, Greece, May 6-9, 2001, which are incorporated herein by reference. Neither refers to WLAN infrastructures, and therefore neither addresses the particular difficulties that must be solved in order to implement beam-forming with distributed antennas in a WLAN infrastructure. These difficulties appear to have prevented the application of such beam-forming to WLAN to date. The difficulties, as well as the solutions provided by the present invention are discussed below.

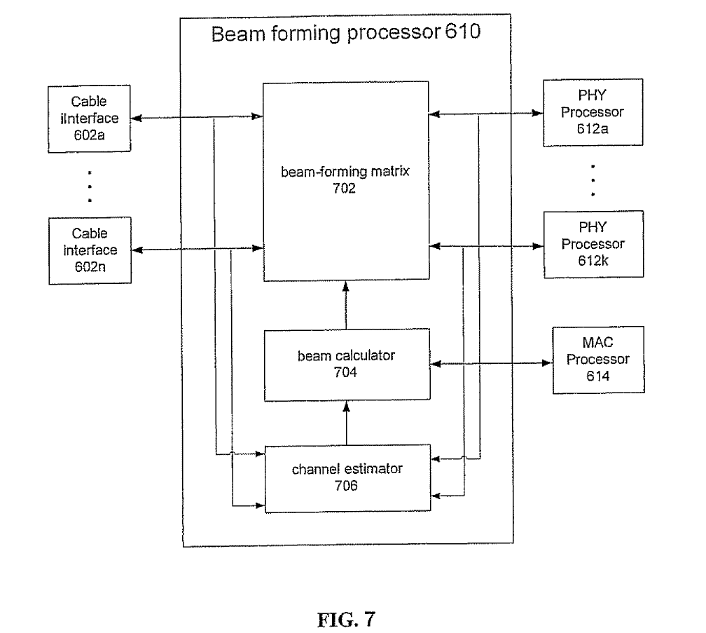

FIG. 7 is an exemplary block diagram showing details of a beam-forming processor 610. The beam-forming processor comprises at least a beam-forming matrix 702 operative to implement the beams, a beam calculator 704 operative to calculate the coefficients used by the beam-forming matrix and a channel estimator 706 operative to provide the beam-calculator with the channel parameters needed for calculating the beam coefficients. In use, channel estimator 706 maintains updated estimates of a RF propagation channel hⱼₖ between each WLAN client j and each antenna unit k. The MAC processor selects a group of clients to communicate with. The beam calculator calculates the beam-forming coefficients for this group of clients. The beam-forming matrix uses those coefficients to implement a set of beams suitable for simultaneous communication with the selected clients. The performance of the beam-forming varies for different combinations of clients.

Beam-forming processor 610 has three modes of operation: dedicated beam-forming, broadcast beam-forming and ad-hoc beam-forming. In dedicated beam-forming mode, M different signals are transmitted to, or received from, a group of M WLAN clients which were selected by the MAC processor 614. In broadcast beam-forming mode, the same signal is broadcast to all WLAN clients. In ad-hoc beam-forming, one or more signals are received from or transmitted to WLAN clients in response to transmissions initiated by the clients.

The following explanations refer to dedicated beam-forming, which is the main mode of operation of the beam-forming processor. Broadcast beam-forming mode and ad-hoc beam-forming are addressed later.

Dedicated Beam-Forming

Based on previous receptions from the wireless clients, channel estimator 706 measures a channel response h^{u}ⱼₖ from WLAN client j to antenna unit k (superscript “u” stands for uplink). Due to the reciprocity of the wireless medium, the channel estimator is also able to estimate a channel response h^{d}ₖⱼ from antenna unit k to WLAN client j (superscript “d” stands for downlink). Repeated adaptation of the channel response ensures that the channel response values are always updated (up to the variation rate of the channel). In the following, we abbreviate h^{u}ⱼₖ and h^{d}ₖⱼ by hⱼₖ whenever the discussion refers to both uplink and downlink.

For narrow band transmissions, hⱼₖ can be considered “flat” and can be represented by a complex scalar. However, for wide band transmissions, due to the multipath effect and the difference in propagation delay, the channel response hⱼₖ is typically frequency dependent and should be represented either as a function hⱼₖ(Z) of a delay z or as a function hⱼₖ(f) of a frequency f. The beam-forming process for “flat” channels is explained next, followed by an explanation of the operation for frequency dependent channels. The first explanation serves as an introduction to the second example.

Referring first to a flat channel, let H be the matrix of channel responses hⱼₖ between M antenna units and N wireless clients that central unit 404 chooses to transmit to during a given time period within the downlink period (N≧M). Let central unit 404 transmit N signals, sᵢ(t), i=1,2, . . . , N, directed each to the corresponding wireless client. Each such signal is called a “stream”. Beam-forming processor 610 through its beam-forming matrix computes a vector of M signals xₖ(t), k=1,2, . . . , M, by the operation x(t)=W·s(t), where W is a M×N complex matrix. The vector of signals rᵢ(t), i=1,2, . . . , N, received at the RF input of the N wireless clients is:

r(t)=H·W·s(t)+n(t) (1)

where n(t) is the thermal noise or other interference not originated from this system. W is computed such that H·W=I, where I is the identity matrix. If this is satisfied, the equation obtained is

r(t)=I·s(t)+n(t)=s(t)+n(t) (2)

In reality, H is not known accurately enough, and W is not generated with absolute accuracy, and therefore

r(t)=s(t)+p(t)+n(t) (3)

where p(t) is the residual mutual interference caused by the inaccuracy in the estimation of H and in the production of W.

The solution of W given H for minimizing the error while conserving the transmit energy is well known, and can be obtained using for example the well known Least Squares method.

The Least Squares formula is well known in the art and is found in many textbooks. For example in “Adaptive Filter Theory” by Simon Haykin is

W=H⁺(HH⁺)⁻¹ (4)

where H⁺ is the transpose and conjugate of H. W is also known as the pseudo-inverse of H. The problem can also be solved using the singular value decomposition theory (same reference)

$$W = V [ \begin{matrix}{Σ}^{- 1} & 0 \\ 0 & 0\end{matrix} ] {U}^{+} \qquad ( 5 )$$

where

$$H = U [ \begin{matrix}Σ & 0 \\ 0 & 0\end{matrix} ] {V}^{+}$$

is the SVD decomposition of H. A small modification of the above is called Minimum mean squared error (MMSE), and is adopted to take into effect the estimation errors and the additive white Gaussian noise.

Referring now to frequency-dependent channels, following are two possible implementations. The first exemplary implementation is to divide the wide band of the channel into L sub-bands, where each sub-band is narrow enough to have a frequency independent response. The wide band signal vector s(t) is divided into L narrow band signal vectors s_{f}(t) by the use of an analysis filter bank, as well known in the art. Each narrow band signal vectors s_{f}(t) is then multiplied by its own matrix W_{f} to provide the narrow band signal vectors x_{f}(t), and the full band signal vector x(t) is synthesized from the narrow band signal vectors x_{f}(t) by the use of the corresponding synthesis filter bank.

The second exemplary implementation is fully in the time domain. Each entry of the matrix M is computed as a polynomial in z (the delay operator), i.e. a finite-impulse-response-filter. Such a matrix can be computed using Least Squares or MMSE principles, as well known in the art of signal processing.

The LS matrix inversion has the property of canceling the interference of other signals to the desired signal. In practice, there are further limitations, like finite transmit power and finite accuracy both in the channel estimation and the inverse generation. Another limitation is the frequency resolution in the filter bank approach or the finite filter length of the time domain solution. Such limitations and inaccuracies are more severe in certain set of channels than in others. There are mathematical tools for evaluation of such effects. Just as an example, observing the size of the singular values can give an estimation on the sensitivity of the channel to the effects above. As the singular values get smaller, the effects are larger.

Channel estimator 706 in FIG. 7 performs two tasks. The first task is to estimate each of the uplink channels {h^{u}ⱼₖ} between each WLAN client and j and each antenna unit k, based on signals received at the antenna units. The second task is to estimate the downlink channels {h^{d}ₖⱼ} between each antenna unit k and each WLAN client j. Next is an explanation on the first task, followed by an explanation of the second task.

Uplink Channel Estimation

Uplink channel estimation may be performed by any of many methods know in the art. One such method correlates the original signal transmitted by a client 104 to the signal received at an antenna unit 402. The original signal transmitted by a client 104 is supplied by the corresponding PHY processor, by means of re-modulating the detected data of the received packet.

Channel estimations need to be carried repeatedly if the channel varies. Every packet transmitted from a wireless client can be used to improve the maintained channel estimation. Channel estimation algorithms are well known in the art and are based on the differences between the received signals and the assumed transmitted signal, which are known or reconstructed from the decoded packet by central unit 404. The reason these signals can be reconstructed by the central unit is that separation of the signals during reception is made with the already known beam matrix, followed by demodulation, decoding, re-encoding and re-modulation. The re-modulated signals are used to obtain a refined channel estimation. In case the current channel estimation is not good enough to separate and decode the signals, only signals that are known a-priory to central unit 404 are used. For example, central unit 404 knows that it is expecting an ACK after a packet it transmitted. This ACK is completely known, as all bits are known to central unit 404, since central unit 404 sent the packet to this wireless client.

Alternatively, when it is not possible to estimate all the relevant individual channel responses based on concurrent reception of the ACK packets, the central unit might schedule its transmissions in such a manner that some of the ACK packets will be received with no interference.

Downlink Channel Estimation

Downlink channel estimation can, in principle, be implemented by incorporation of a channel estimation function in each WLAN client and by feeding the output of those functions to the central unit. Yet, the WLAN infrastructure described in the present invention is invention to serve off-the-shelf standard WLAN clients, which do not provide such service, and therefore we introduce here a method estimating the downlink channels {h^{d}ⱼₖ} based on the corresponding uplink channels {h^{u}ⱼₖ}

As well known in the art, the RF propagation channel gₖⱼ from the antenna of a given antenna unit k to the antenna of a given wireless client j is indeed reciprocal. Yet, the downlink channel h^{d}ⱼₖ is typically different from the uplink channel a h^{u}ⱼₖ, because these channels depend not only on the RF propagation channel gₖⱼ but also on the parameters of the transmitters and the receivers of the antenna unit and of the WLAN client, such as carrier phase, gain, impedance matching and different filter responses. Therefore, in order to implement beam-forming in a WLAN infrastructure that serves standard WLAN clients it is generally essential to implement a special calibration process, as explained next.

As explained above, the channel response h jk from WLAN client j to antenna unit k depends on the parameters of the transmitter of WLAN client j, the RF propagation channel gₖⱼ and the parameters of the receiver of antenna unit k. This fact can be expressed in the following equation:

h^{d}ⱼₖ=Txⱼ·gₖⱼ·Rxₖ (6)

where Txⱼ and Rxₖ represent the combined effect of all relevant transmitter and receiver parameters, respectively. Following a similar notation,

h^{u}ⱼₖ=Txₖ·gₖⱼ·Rxⱼ (7)

As also explained above, the transfer function of a given channel can be expressed either in time domain (as a polynomial in z) or in frequency domain (as a vector of complex values, one per frequency spot). Combining the equations 6 and 7, we get the following relationship between the uplink channel response estimated by channel estimator 706 and the downlink channel response required by beam calculator 704:

h^{d}ⱼₖ=h^{u}ⱼₖ·Aⱼ/Bₖ (8)

where Aⱼ=Txⱼ/Rxⱼ and Bₖ=Txₖ/Rxₖ. Factor Aⱼ above is a function of the parameters of the transmitter and the receiver of antenna unit j, and is typically identical to all downlink/uplink channel pairs originating/terminating at the given antenna unit. The accurate value of this factor is essential for beam calculator function 704. Factor Bₖ is a function of the corresponding parameters of the given wireless client, and is identical to all downlink/uplink channel pairs terminating/originating at the given wireless client. Factor B is not material for beam calculator function 704 since it affects the signal after the interference is already cancelled in the downlink or before the signal is output for the uplink.

Therefore, in order to implement downlink beam-forming in a WLAN infrastructure that serves standard WLAN clients, it is essential to have a method to determine the accurate value of the factor Aⱼ for each antenna unit j. This fact applies as well to other wireless access system in which the clients do not typically incorporate a mechanism to provide feedback on the channel response.

In principle, factors Aⱼ can be set to a pre-determined value by means of calibration performed either in the factory or on-line. Yet, such calibration may be difficult to perform and therefore may have a negative effect on the economics and maintainability of the system. Alternatively, these factors can be measured in field as follows:
1. Select some antenna unit j as a starting point.
2. Set Xⱼⱼ=1.
3. Select some antenna unit k such that antenna units j and k receive each other's transmissions.
4. Send a predefined signals from antenna unit j to antenna unit k, and vice versa.
5. Measure the received signals and correlate them with the transmitted signals.
6. Calculate the channel responses hⱼₖ and hₖⱼ.
7. Calculate Xₖⱼ=hₖⱼ/hⱼₖ=Aₖ/Aⱼ.
8. Repeat 2 to 6 above with as many antenna units k as possible.
9. If Xₖⱼ has been calculated for all antenna units then the task is completed, otherwise continue to the next step.

10. Select some antenna unit m for which Xₖⱼ has not yet been calculated such that there is some antenna unit k for which Xₖⱼ has already been calculated and such antenna units k and m receive each other's transmissions.
11. In a similar way, measure and calculate Xₘₖ=Aₘ/Aₖ.
12. From the above calculate Xₘⱼ=Xₘₖ/Xₖⱼ=Aₘ/Aⱼ.
13. Repeat 10 to 12 above until Xₘⱼ has been calculated for all for all antenna units m.

The result of the above process is a set of factors Xₖⱼ for all antenna units k, which are equal to the required factors Aₖ up to some unknown factor Aⱼ. However, factor Aⱼ is not material for the operation of the beam-forming calculator, since it is identical to all antenna units.

Referring to beam calculator 704 in FIG. 7, its function is to calculate the matrices W based on data provided by channel estimator 706, using, for example, the methods explained above. For “flat” narrow band channels, matrix W may be a matrix of complex scalars. For more practical frequency dependent wide band channels there are two alternatives: frequency domain processing and time domain processing, as explained above. For frequency domain processing, matrix W is composed of L W_{f}, one per sub-band f. For time domain processing, matrix W is composed of polynomials in z, where z is the delay operation.

Referring to beam-forming matrix 702 in FIG. 7, its function is to implement matrix W (either in frequency domain or in time domain) as calculated by beam calculator 704.

As mentioned, two other modes of operation of the beam-forming processor 610 are broadcast transmission beam-forming and ad-hoc reception beam-forming.

Broadcast Beam-Forming

This mode is used to transmit broadcast frames to all WLAN clients. In this mode, one signal, which is intended to be received by all WLAN clients, is being broadcasted via one broadcast beam. The broadcast beam is created by transmitting the same signal from all antenna units with the same amplitude. The effect of the same signal being transmitted by several antenna units is, in principle, similar to the effect of an intensive multipath pattern. Since WLAN clients are typically designed to operate in an intensive multipath environment, the probability of the broadcast signal will be detected by all WLAN clients is high. To further increase this probability, two measures are taken. The first measure is to transmit the broadcast frames at a low transmission rate. The second method is to select the phases of transmission from the antenna units randomly at each transmission, so as to further reduce the probability of consecutive transmissions not being detected by the same WLAN client.

Ad-Hoc Beam-Forming

This mode is used to receive one or more frames transmitted by one or more WLAN clients, when the identity of the transmitting client is not known in advance to the central unit. In this mode, one or more beams are created in real-time according to the signals received at the antenna units. If only one single transmission is detected, the corresponding beam can, for example, be created by selecting the output of the antenna unit with the highest receive power level. If a plurality of transmissions is detected simultaneously, beam-forming coefficients can be calculated based on the channel estimation derived from the reception of the deterministic header of the frames. The later operation requires delaying the received signals in memory enough time to allow for the channel estimation and beam calculation to be completed. Ad-hoc beam-forming is also used to transmit the ACK relay to frames received via ad-hoc beam-forming.

Special Features of the Disclosed WLAN Beam-Forming

The essential differences between the beam-forming of the present invention and prior art, and in particular the differences between WLAN beam-forming as disclosed herein and prior art cellular communications beam-forming, are now emphasized and described in detail:

1. The WLAN beam-forming of the present invention (with distributed antennas) is fundamentally different from prior art beam-forming (with collocated antennas), in that in prior art beam-forming, the zeros are placed in selected directions while in our beam-forming zeroes are placed in selected places.
2. Advantageously, in the disclosed WLAN beam-forming of the present invention:
a. The antennas are distributed over the entire service area. There is therefore a much higher probability that for each client there will be at least one antenna unit with good propagation conditions (e.g. antenna units which happen to be close to client and with no obstacles between them and the client). This improves the probability of the system to be able to serve all clients at high communication rates.
b. Each WLAN client has typically some antenna units to which it is closer than to others, and the channel attenuation toward these antenna units is typically smaller than the channel attenuation to the other antenna units. Therefore, the probability that the scheduler is able to selects a group of clients for simultaneous communication, having a channel matrix easily invertible, is very high. A matrix that is hard to invert, therefore possibly leading to decreased performance, is called close to singular. In mathematical form, the correlation matrix HH⁺ has large diagonal and small off-diagonal terms, which leads to low singular value spreads.

Multi-stream MAC processor 606 in FIG. 6 implements all prior art functions of the MAC layer of the WLAN. For example, for WLAN according to IEEE 802.11 standard, MAC processor 606 implements all MAC functions described in this standard. In addition, MAC processor 606 also implements special MAC functions, which enable the operation of the beam-forming function. The special functions of the multi-stream MAC processor include: a) arranging the communication with the clients in down-stream slots of simultaneous beam-forming (or simultaneous transmission by means of beam-forming) and b) selecting (scheduling) sets of clients for simultaneous beam-forming.

As explained above, contrary to the common practice in WLAN art, where each antenna is used to communicate with one client at a given time, in the present invention all antenna units are used simultaneously at a given time to communicate with a selected group of clients by means of a set of corresponding beams created in real time. Therefore, in order to enable the beam-forming operating, the MAC processor 706 arranges the communication with the clients in slots, where in each slot is utilized for communication with a given group of clients, as described below. This slotted arrangement, which enables beam-forming, is fundamentally different from the known operation of WLAN infrastructure systems according to the IEEE 802.11 standard.

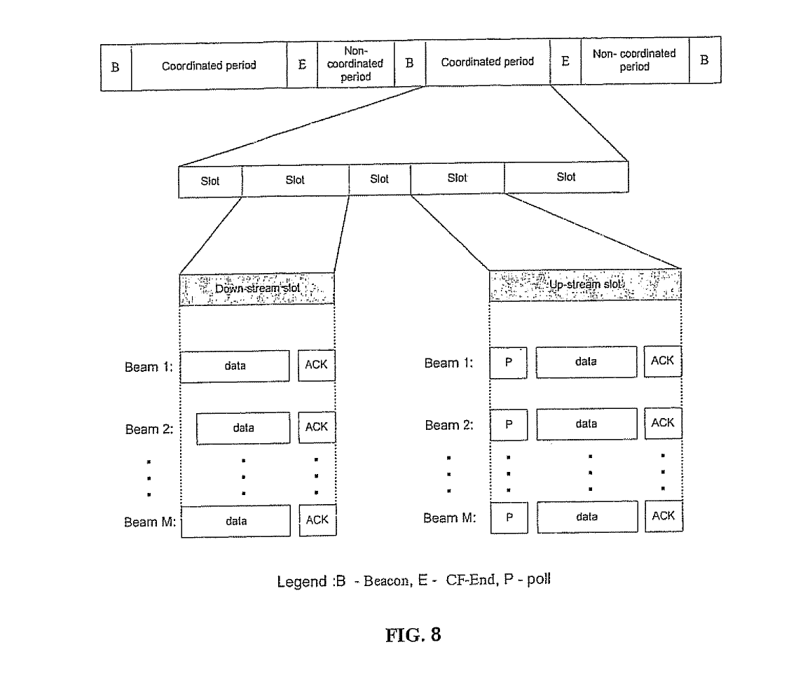

The operation of MAC processor 706 is presented in FIG. 8. The time axis is divided into coordinated periods and a non-coordinated periods, and the coordinated periods are further divided into slots, where each slot is used for communication with a given group of clients. Each slot might be either a down-stream slot or an up-stream slot, as explained below.

During the coordinated period, all transmissions to and from the WLAN clients are initiated by MAC processor 706 and the WLAN clients are not allowed to initiate transmission during the coordinated period. During the non-coordinated period the WLAN clients are allowed to initiate transmissions, and the MAC processor replies to those transmissions with ACK frames, as appropriate. The MAC processor typically does not initiate transmissions during this period. During the non-coordinated period, the beam-forming processor operates in ad-hoc mode, as explained above.

Signals or messages indicating the coordinated period and the non-coordinated period are broadcast to the WLAN clients by the MAC processor, using the broadcast mode of the beam-forming processor. For WLAN according to the IEEE 802.11 standard, these messages are preferably the beacon frames and the CF-end frames according to the PCF (point coordination function) of the standard. Alternatively, these messages may also be other control frames that set the NAV (Network Allocation Vector), so that the wireless clients are not allowed to transmit during this period (for example CTS frames).

Down-Stream Operation (or Down-Stream Slots)

The fragmentation feature of the 802.11 MAC is utilized to keep the down-stream operation efficient. An optimal common frame duration is selected, and each down-stream frame longer than the common duration is fragmented as known in the art to common duration. The common frame duration might be varied dynamically according to traffic type and rate considerations.

Before the beginning of each down-stream slot, the MAC processor selects a set of m WLAN clients to communicate with. The function of selecting the set of WLAN clients for simultaneous down-stream transmission is referred to as scheduling and is explained below.

At the beginning of the slot, the beam-forming processor implements the corresponding set of m beams, and the MAC processor transmits m frames simultaneously, one per selected client, via PHY processors 704, beam-forming matrix 702 and antenna units 402. A frame shorter than the common frame duration (either an original short frame or the last fragment of an original long frame) is delayed relative to the other frames, such that its end time is timed exactly at the same position as the others.

After the in frames have been transmitted, the antenna units, beam-forming matrix and PHY processors are switched (under the control of the MAC processor) from transmission mode to reception mode, and the ACK frames transmitted by the WLAN clients are received.

Up-Stream Operation (or Up-Stream Slots)

Before the beginning of each up-stream slot, the MAC processor selects a set of m WLAN clients to communicate with. At the beginning of the slot the beam-forming processor implements the corresponding set of m beams and the MAC processor transmits m polling frames simultaneously, one per selected client, via PHY processors 612, beam-forming matrix 702 and antenna units 402. After the m frames have been transmitted, the antenna units, beam-forming matrix and PHY processors are switched (under the control of the MAC processor) from transmission mode to reception mode, and the frames transmitted by the WLAN clients are received. After those frames has been received, the antenna units, beam-forming matrix and PHY processors are switched again into transmission mode and the appropriate ACK replies are transmitted.

As explained above, coordinated up-stream transmission requires the utilization of polling frames. In WLAN according to the IEEE 802.11 standard, polling messages are part of the standard, but responding to those frames is not mandatory and contemporary 802.11b/g/a WLAN clients typically do not implement this capability. Therefore, coordinated up-stream transmission is typically not viable with contemporary 802.11b/g/a WLAN clients. Yet, new QoS polling frames are introduced by the emerging 802.11e extension to the 802.11 standard, and responding to these frames is expected to be mandatory for QoS compliant clients. Therefore, coordinated up-stream transmission is expected to become viable for emerging 802.11e QoS-capable clients.

In the preferred embodiment of the current invention, for proper up-stream operation in the coordinated slots, at least one of the following should be implemented by the WLAN clients:
1. Utilization of the no-ACK feature of the emerging 802.11e.
2. Re-arranging the data in fixed duration frames, which can be achieved, for example, by means of an intermediate layer between the IP layer and the WLAN MAC layer.

MAC Processor Scheduling Function

As explained above, the task of the scheduling function is to select the next set of WLAN clients to communicate with during the down-stream period or the up-stream period.

Referring now to scheduling for down-stream, as known in the art, the MAC processor maintains a queue of out-standing frames for each WLAN client associated with it. If priority is implemented, as for example in the emerging 802.11e extension to the 802.11 standard, MAC processor 606 maintains a queue of out-standing frames for each associated WLAN client and for each priority level. The operation of the down-stream scheduler is based on the content of these queues. The goals of the down-stream scheduler are on one hand to satisfy, as much as possible, the traffic requirements of the individual WLAN clients and on the other hand to obtain maximal aggregated throughput by maximal utilization of the wireless media. The down-stream scheduler can be implemented utilizing a variety of algorithms. One such algorithm (a greedy algorithm) is presented next as an example:
1. Set the group of selected clients to be empty, the group of rejected clients to be empty and the group of potential clients to be equal to the group of all clients.
2. Find within the group of potential clients the client with the highest traffic requirement. This function might be defined in various ways. One possible example is to take all outstanding frames of all potential clients, find the frame with the highest priority, and then find the potential client with the largest queue of frames of that priority.
3. If no such client with non-zero traffic requirements can be found, go to 10.
4. Add the above client, tentatively, to the group of selected clients and remove it from the group of potential clients.
5. Produce the channels matrix H of the selected clients.
6. Calculate the beam-forming matrix W that corresponds to the channel matrix H.
7. Check whether W can be implemented under the constrains of the system and whether the resulting SNR is sufficient.
8. If the answer to 7 is positive, go to 2.
9. If the answer of 7 is negative, remove the tentative client from the group of selected clients, add it to the group of rejected clients and go to 2.
10. Exit.

Referring now to scheduling for up-stream, the algorithm may be based on similar principles to those of the algorithm for down-stream scheduling. One major different may be the fact that the information on the traffic requirements of each client is now based on feedback from the clients rather than on the actual queues of the out-standing frames.

Referring to the non-coordinated uplink operation example, during the non-coordinated periods, the wireless clients are operating according to the well known prior art CSMA (carrier sense multiple access) algorithm which is implemented independently of this invention. Central unit 404 may be in the situation that it has to respond with an ACK, CTS (clear to send), or other control packet and in the same time receive other wireless clients packets. In case antenna unit 402 cannot receive and transmit in the same time, one (or a few together) of the available antenna units, which preferably is the closer antenna unit to that wireless client, transmits to it and the other can still receive the other wireless clients but there will be some level of interference if there is no beam-forming function employed in the system. In case there is a beam-forming function, it is configured such that the interference caused by the transmitting antenna unit to the other receiving antenna units is cancelled.

In case central unit 404 detects two or more packets at the same time, it will try to separate them. There are known in the art algorithms, operable in central unit 404, for detecting and separating multiple packets, even if they are received in the same antenna units, overlapping in time. An exemplary way of separating multiple packets is by using the beam-forming function. First the signal is delayed by storing it in memory sufficient time to allow detection of at least part of synchronization sequence or one of any set of signals known to be present in received packets. Once the known part of the packet is detected, the channel coefficients between the transmitting client and all receiving antenna units is estimated, and than calculation is done to form a beam separation solution. One set of methods to do that is the known in the art “de-correlator” method.

In the case where there is more than one RF channel available (for example in the 802.11b there are three relatively non interfering channels) the algorithms described above apply separately to the group of antenna units allocated to the same RF channel and to the group of wireless clients associated with this group of antenna units. The process of allocating RF channels to the antenna units is known in the art as RF planning.

In an alternative embodiment of the current invention the antenna units are broadband and covers the whole set of channels (e.g. covering the whole 80 MHz spectrum in 2.4 GHz). In such system each antenna unit can serve in the beam forming generation of beams of all channels. The advantage generated in such arrangement is an effective increase in the number of antennas covering the area and increased flexibility. Furthermore, the beam-forming unit can in this case cancel also the interference between different frequency channels. Such inter-channel interference canceling is a unique feature of this invention.

In an alternative embodiment of the current invention, all or a selected group of antenna units are used simultaneously at a given time to communicate with a selected group of one or more clients by means of a set of corresponding beams created in real time. In case several groups of one or more clients are communicating with several groups of antenna units, in order to enable the beam-forming operating, the MAC processor 706 arranges the communication with the clients in multiple streams each divided into slots, where in each slot is utilized for communication with a given group of clients. Such multiple streams can be optionally not synchronized. For example transmission through one antenna group can coincide with receiving in other antenna group. Interference between the groups are minimized by the scheduling function of the MAC processor 706 and by the beam-forming unit.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

It is to be understood that the present invention is not limited in its application to the details of the order or sequence of steps of operation or implementation of the system and corresponding method, set in the description, drawings, and examples of the present invention.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described in conjunction with specific embodiments and examples thereof, it is to be understood that they have been presented by way of example, and not limitation. Moreover, it is evident that many alternatives, modifications and variations will be apparent to those skilled in the art. Accordingly, it is intended to embrace all such alternatives, modifications and variations that fall within the spirit and broad scope of the appended claims and their equivalents.

What is claimed is:

1. A wireless local area network (WLAN) access point (AP) system comprising:
a. a first plurality of distributed antenna units operative to transmit and receive RF signals, and
b. a central WLAN beam-forming unit remote from and connected to each distributed antenna unit and operative to provide communication to a second plurality of wireless clients through at least part of the antenna units;
whereby the WLAN AP system can be used for simultaneous communications with the wireless clients over the same radio frequency (RF) channel.

2. The WLAN AP system of claim 1, wherein the central WLAN beam-forming unit is connected to each antenna unit by a cable.

3. The WLAN AP system of claim 2, wherein the communication over each cable is by a high rate, low latency digital link.

4. The WLAN AP system of claim 2, wherein the communication over each cable is by analog base-band, IF or RF signals.

5. The WLAN AP system of claim 2, wherein each cable is a twisted pair cable.

6. The WLAN AP system of claim 5, wherein the communication over each twisted pair cable is by a high rate, low latency digital link.

7. The WLAN AP system of claim 5, wherein the communication over each twisted pair cable is by analog base-band signals.

8. The WLAN AP system of claim 5, wherein each twisted pair cable is selected from the group consisting of a CAT5 cable, a CAT6 cable and a CAT7 cable.

9. The WLAN AP system of claim 8, wherein the high rate, low latency digital link is 1000BaseT according to the IEEE 802.3 standard.

10. The WLAN access point system of claim 2, wherein the central WLAN beam-forming unit further includes:
i. a beam-forming processor operative to form and process beams for the distributed antennas,
ii. at least one PHY processor operative to output a PHY signal,
iii. a multi-stream MAC processor operative to centrally implement a MAC layer for all the distributed antenna units through each PHY processor and the beam-forming processor, and
iv. a respective cable interface for connecting to each cable.

11. The WLAN access point system of claim 10, wherein the central WLAN beam-forming unit further includes:
v. a central reference source coupled to each cable interface and operative to output a signal used in locking all antenna units to a common central frequency.

12. The WLAN access point system of claim 10, wherein each antenna unit includes:
i. an antenna,
ii. a RF transceiver for effecting the communications with the wireless clients through the antenna, and
iii. an antenna unit cable interface for connecting the antenna unit to its respective cable.

13. The WLAN access point system of claim 10, wherein each antenna unit further includes:
iv. a reference signal generator operative to provide reference frequency signals for an RF function and optionally for a base-band function, the frequency signals locked on the central reference source signal.

14. The WLAN access point system of claim 10, wherein the beam-forming processor includes a beam-forming matrix operative to implement the beams, a beam calculator operative to calculate coefficients used by the beam-forming matrix and a channel estimator operative to provide the beam-calculator with channel parameters needed for calculating the beam coefficients.

15. A wireless local area network (WLAN) access point (AP) system comprising a central beam-forming unit operative to effect communications between a first plurality of wireless LAN clients through a second plurality of distributed antenna units that are remote from the central beam-forming unit, wherein the communications occur simultaneously over a single common radio frequency (RF) channel.

16. The WLAN AP system of claim 15, further comprising a same second plurality of cables that connect the antenna units to the central beam unit.

17. The WLAN AP system of claim 15, wherein each cable of the plurality is a twisted pair cable.

18. The WLAN AP system of claim 17, wherein each twisted pair cable is selected from the group consisting of a CAT5 cable, a CAT6 cable and a CAT7 cable.

19. The WLAN access point system of claim 15, wherein the central beam-forming unit includes:
i. at least one PHY processor operative to output a PHY signal,
ii. a multi-stream MAC processor coupled to each PHY processor and operative to centrally implement a MAC layer for all the distributed antenna units, and
iii. a beam-forming processor operative to enable each PHY processor to communicate with the wireless clients over the same RF channel without mutual interference.

20. The WLAN access point system of claim 19, wherein the central beam-forming unit further includes
iv. a respective cable interface for connecting to each cable, and
v. a central reference source coupled to each cable interface and operative to output a signal used in locking all antenna units to a common central frequency.

21. In a wireless local area network (WLAN) infrastructure, a method for enabling simultaneous communication with a plurality of WLAN clients over the same radio frequency (RF) channel without mutual interferences, comprising the steps of:
a. providing a first plurality of distributed antenna units; and
b. using a central WLAN beam-forming unit connected remotely to each distributed antenna unit to effect simultaneous communications with at least some of the clients through at least some of the distributed antenna units over the same RF channel without mutual interferences.

22. The method of claim 21, wherein the step of using a central WLAN beam-forming unit includes using the central WLAN beam-forming unit to perform WLAN beam-forming with distributed antennas.

23. The method of claim 22, wherein the performing of WLAN beam-forming with distributed antennas includes dedicated beam-forming.

24. The method of claim 22, wherein the performing of WLAN beam-forming with distributed antennas includes performing an action selected from the group of broadcast transmission beam-forming and ad-hoc beam-forming.

25. The method of claim 21, wherein the step of using a central WLAN beam-forming unit includes providing a beam-forming processor operative to form and process beams for the distributed antennas, providing at least one PHY processor operative to output a PHY signal, and providing a multi-stream MAC processor operative to centrally implement a MAC layer for all the distributed antenna units through each PHY processor and the beam-forming processor.

26. A method for interference-free communication with N wireless local area network (WLAN) clients over the same radio frequency (RF) channel comprising the steps of:
a. using M distributed antenna units located remotely from a central beam-forming unit to form N beams for the N clients in real time, wherein N is equal to or smaller than M; and
b. communicating via the N beams simultaneously over the same RF channel with the N wireless clients.

27. The method of claim 26, wherein the forming of N beams in real time includes forming each beam to transmit or receive energy to a location of a chosen client and to transmit or receive almost no energy to and from locations of the remaining N−1 wireless clients.
